(19) United States
(12) Patent Application Publication
(10) Pub. No.: US 2007/0127427 A1
(43) Pub. Date: Jun. 7, 2007

(54) Communication system, control terminal and communication terminal

(75) Inventor: Hironori Tanaka, Fukuoka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/593,630

(22) Filed: Nov. 7, 2006

(30) Foreign Application Priority Data
Nov. 9, 2005 (JP) P. 2005-324496

(51) Int. Cl. H04Q 7/24; H04J 3/00

(52) U.S. Cl. 370/338; 370/345

(57) ABSTRACT

A control terminal 1a, 1b transmits a beacon frame including information necessary for connecting a communication terminal 2 to the control terminal 1a, 1b per se at each previously determined beacon interval, transmits a presence informing frame showing presence of the control terminal 1a, 1b at least one within the beacon interval, and the communication terminal 2 selects the control terminal 1a, 1b to be connected based on the beacon frame and/or the presence informing frame received.

### BACKGROUND

The present invention relates to a communication system in which a communication terminal is connected to a control terminal by using a wireless network and a communication is carried out by way of the control terminal, particularly relates to connection of a connection terminal and a control terminal.

A communication system using wireless LAN (Local Area Network) has been spread remarkably. According a communication system using wireless LAN, a communication terminal searches a communicable control terminal, and selects to connect to a control terminal having the best condition in searched control terminals. Currently, IEEE (Institute of Electrical and Electronic Engineers) 802.11 constituting a standard of wireless LAN which is spread the most rectifies a method by which a communication terminal searches a control terminal to select a control terminal to be connected.

For example, (Nonpatent Reference 1) discloses methods of passive scan and active scan. It is possible based on the methods to search a control terminal by using a beacon frame or a probe response frame, receive the beacon frame or the probe response frame by a plurality of times (for example, 3 times) and select a control terminal to be connected based on information of a receiving intensity thereof.

An explanation will be given of a method of searching and selecting a control terminal in a communication system of a background art described in (Nonpatent Reference 1) in reference to FIG. 13 through FIG. 16 as follows. FIG. 13 is a constitution diagram showing an example of a communication system using wireless LAN of a background art. FIG. 14 is a diagram showing a constitution of a physical layer frame rectified in IEEE 802.11. FIG. 15 is a sequence diagram for explaining an operation when a control terminal is searched by using passive scan.

In FIG. 13, a communication system using wireless LAN of a background art includes a plurality (two sets in this case) of control terminals 1000a, 1000b and one or a plurality. (1 set in this case) of a communication terminal 2000. The control terminals 1000a, 1000b are connected to a wired network of the internet or the like, not illustrated, by way of a wired channel 4000 and connected to a wireless network (wireless LAN) by way of wireless channels 3000a, 3000b. The communication terminal 2000 is connected to the control terminal 1000a by way of the wireless channel 3000a, or connected to the control terminal 1000b by way of the wireless channel 3000b and connected to the wired network by way of the control terminal 1000a, 1000b.

The control terminals 1000a, 1000b and the communication terminal 2000 carry out a communication by using a physical layer frame 100 rectified in IEEE 802.11 shown in FIG. 14. In FIG. 14, the physical layer frame 100 is constituted by a Physical Layer Preamble 101 used for establishing synchronization of the physical layer, a PHY header 102 set with information of data rate, data link layer frame length or the like, and a data link layer frame 103 rectified by IEEE 802.11.

The data link frame layer 103 is constituted by an MAC (Medium Access Control) header 104 set with information indicating which kind of a frame the data link layer frame 103 is (beacon frame or probe request frame, probe response frame, ACK frame or the like), information (data) of a destination address indicating a destination or a transmission source address indicating a transmission source of the data link layer frame 103, a frame body (Frame body) 105 set with various data in accordance with a kind of a frame set to the MAC header 104, and FCS (Frame Check Sequence) 106 set with information for confirming properness of a content of data set to the MAC header 104 and the frame body 105. As information for confirming the properness of the content of the data set to the MAC header 104 and the frame body 105, there is used CRC (Cyclic Redundancy Code) of 32 bits calculated by the data set to the MAC header 104 and the frame body 105.

First, an explanation will be given of a method of searching and selecting a control terminal by a passive scan using a beacon frame disclosed in (Nonpatent Reference 1) in reference to the sequence diagram of FIG. 15. The control terminal 1000a transmits a beacon frame at every constant beacon interval by using Channel 1, and the control terminal 1000b transmits a beacon frame at every beacon interval the same as that of the control terminal 1000a by using Channel 6. However, beacon transmitting times of the control terminal 1000a and the control terminal 1000b differ from each other.

The communication terminal 2000 receives beacon frames B11 through B13 transmitted by the control terminal 1000a by using Channel 1, thereafter, receives beacon frames B21 through B23 transmitted by the control terminal 1000b by using Channel 6. That is, the communication terminal 2000 receives the beacon frames from the control terminal 1000a consecutively by 3 times, thereafter, receives the beacon frames from the control terminal 1000b consecutively by 3 times and selects a control terminal having excellent receiving intensity information.

Here, a time period necessary for the communication terminal 2000 to search the control terminals 1000a, 1000b is constituted by a time period of an average amount of 5 pieces of beacon intervals constituted by adding an average amount of 0.5 piece of an amount of 0 through 1 piece of the beacon interval until receiving the initial beacon frame B11 from the control terminal 1000a by a timing of starting search, and an average amount of 4.5 pieces of an amount of 4 through 5 pieces of beacon intervals by a relative time difference of beacon frame transmission of the control terminal 1000a and beacon frame transmission of the control terminal 1000b until receiving the third beacon frame B23 after receiving the initial beacon frame B11 of the control terminal 1000a.

Further, (Nonpatent Reference 2) discloses a technology in which a control terminal to be connected is not selected only from information of a receiving intensity of a beacon frame or a probe response frame as in the technology of the background art described in (Nonpatent Reference 1) but a control terminal to be connected is selected based on information of a receiving intensity of a beacon frame or a probe response frame and a state of the control terminal.

Specifically, the control terminal 1000a, 1000b transmits a beacon frame comprising the physical layer frame 100 previously shown in FIG. 14, the beacon frame or the probe response frame attached with QBSS Load Element added with 7 bytes of QBSS (Quality of service Basic Service Set) Load element 107 determined by IEEE 802.11e standard candidate shown in a drawing indicating a constitution of 7 bytes of QBSS Load Element determined by IEEE 802.11e candidate standard of FIG. 16.

QBSS Load element 107 is constituted by 1 byte of Element ID108, 1 byte length 109, 2 bytes of Station Count 110, 1 byte of Channel Utilization 111, and 2 bytes of Available Admission Capacity 112.

Element ID 108 is set with a value of specifying what is indicated by information successive to Element ID108 and is set with “11” in this case. Length 109 is set with what byte of information is present at and after Length 109, and set with “5” in this case. Station Count 110 is set with a number of communication terminals currently controlled by a control terminal. Channel Utilization 111 is set with a rate of utilizing frequencies controlled by the control terminal. Available Admission Capacity 112 is set with an amount of time which can be controlled by the control terminal by a unit of 32 μs.

The communication terminal 2000 receives a beacon frame attached with QBSS Load element or a probe response frame and selects a control terminal to be connected based on receiving intensity information, the number of communication terminals the rate of utilizing frequencies controlled by the control terminals 1000a, 1000b set to QBSS Load element 107 and a controllable time amount.

[Nonpatent Reference 1] ANSI/IEEE Std 802.11, 1999 (pages 125-127)

[Nonpatent Reference 2] IEEE P802.11e/D13.0, January 2005 (pages 39, 40, 50)

However, when passive scan is used, a time period of an amount of several pieces of beacon intervals is needed until selecting the control terminal to be connected after the communication terminal starts searching the control terminal to pose a problem that time is taken until connecting to the control terminal.

### SUMMARY

The invention has been carried out in view of the above-described and it is an object thereof to provide a communication system shortening a time period of searching a control terminal when a communication terminal selects a control terminal to be selected and restraining a medium necessary for search from being used.

In order to resolve the problem, according to the invention, there is provided a communication system comprising a control terminal and a communication terminal connected to the control terminal by way of a wireless channel, wherein the control terminal comprises a control terminal side control unit for instructing to generate a first frame including information necessary for connecting the communication terminal to the control terminal per se at every predetermined time interval and instructing to generate at least or more of second frames each including information by which the communication terminal can identify the control terminal per se and having a data amount smaller than a data amount of the first frame within the first frame interval, a wireless controller for generating the first frame and the second frame in accordance with an instruction of generating the frames from the control terminal side control unit, and a transmitting unit for transmitting the first frame and the second frame generated by the wireless controller to the wireless channel by using a frequency previously allocated to the control terminal per se, and wherein the communication terminal comprises a receiving unit for receiving the frame from the wireless channel at the instructed frequency, a wireless module for determining whether the frame received by the receiving unit is the first frame or the second frame, and a communication terminal side control unit for instructing the frequency to be searched and confirming presence of the control terminal based on the first frame or the second frame determined by the wireless module.

### BRIEF DESCRIPTION OF THE DRAWINGS

FIG. 1 is a constitution diagram showing an example of a constitution of Embodiment 1 of a communication system using wireless LAN according to the invention.

FIG. 2 is a perspective view of an outlook of a front face of a control terminal shown in FIG. 1.

FIG. 3 is a perspective view of an outlook of a rear face of the control terminal shown in FIG. 1.

FIG. 4 is a constitution diagram of a hardware of the control terminal shown in FIG. 1.

FIG. 5 is a functional block diagram of the control terminal shown in FIG. 1.

FIG. 6 is a perspective view of an outlook of a communication terminal shown in FIG. 1.

FIG. 7 is a constitution diagram of a hardware of the communication terminal shown in FIG. 1.

FIG. 8 is a functional block diagram of the communication terminal shown in FIG. 1.

FIG. 9 is a sequence diagram for explaining an operation of Embodiment 1 of the communication system according to the invention.

FIG. 10 is a sequence diagram for explaining an operation of Embodiment 2 of a communication system according to the invention.

FIG. 11 is a sequence diagram for explaining an operation of Embodiment 3 of a communication system according to the invention.

FIG. 12 is a sequence diagram for explaining an operation of Embodiment 4 of a communication system according to the invention.

FIG. 13 is a constitution diagram showing an example of a communication system using wireless LAN of the background art.

FIG. 14 is a diagram showing a constitution of a physical layer frame rectified by IEEE 802.11.

FIG. 15 is a sequence diagram for explaining an operation of a case of searching a control terminal by using passive scan.

FIG. 16 is a diagram showing a constitution of QBSS Load element of 7 bytes determined by a standard candidate of IEEE 802.11e.

### EMBODIMENT

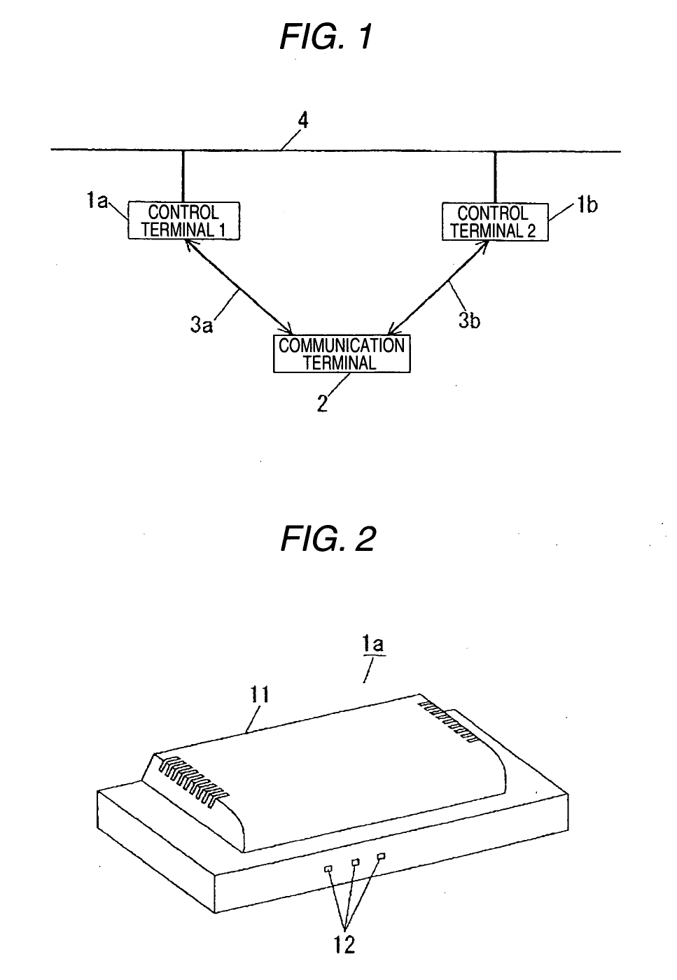

Embodiments of the invention will be explained in reference to FIG. 1 through FIG. 12 as follows. Further, the invention is not limited the embodiments.

(Embodiment 1)

Embodiment 1 of the invention will be explained. FIG. 1 is a constitution diagram showing a constitution of Embodiment 1 of a communication system using wireless LAN according to the invention. In FIG. 1, notations 1a, 1b designate control terminals, notation 2 designates a communication terminal, notations 3a, 3b designate wireless channels, notation 4 designates a wired channel.

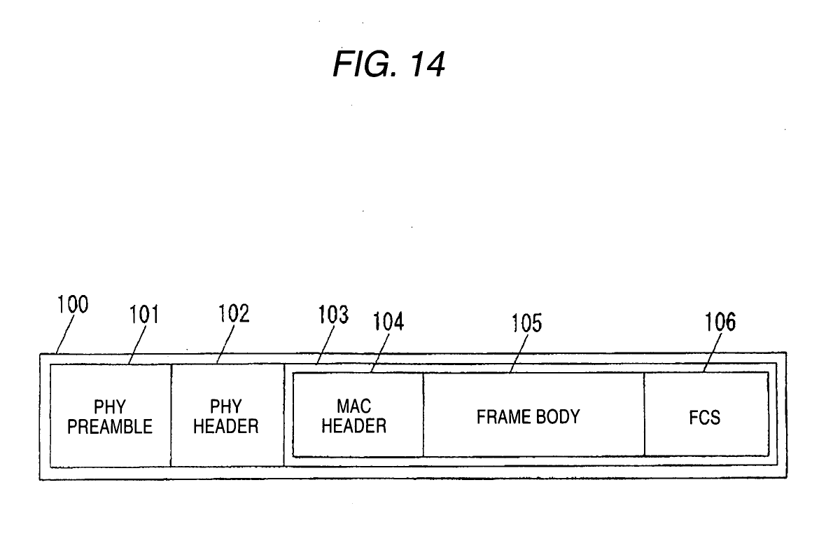

In FIG. 1, the communication system includes a plurality (2 sets in this case) of the control terminals 1a, 1b and one or a plurality (1 set in this case) of the communication terminal 2. The control terminals 1a, 1b are connected to a wireless network of the internet or the like, not illustrated, by way of the wireless channel 4 and connected to a wireless network (wireless LAN) by way of the wireless channels 3a, 3b. The communication terminal 2 is connected to the control terminal 1b by way of the wireless channel 3a, or connected to the control terminal 1a by way of the wireless channel 3b, and connected to the wired network by way of the control terminals 1a, 1b. The control terminals 1a, 1b and the communication terminal 2 carry out a communication by using the physical layer frame 100 rectified in IEEE 802.11 previously shown in FIG. 14.

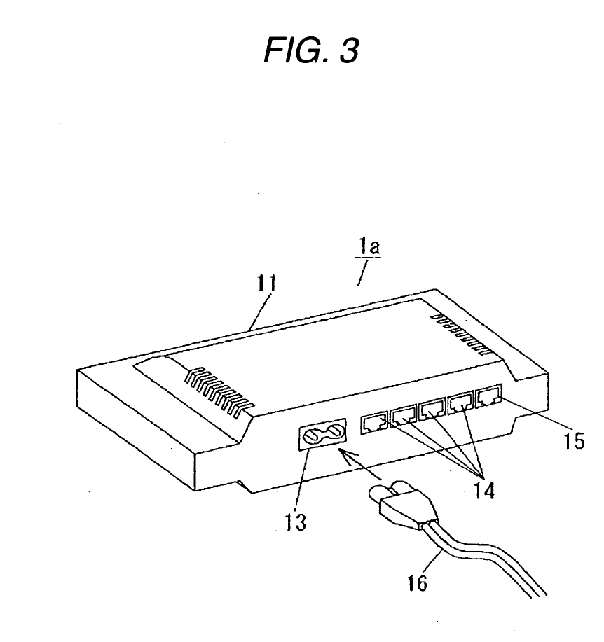

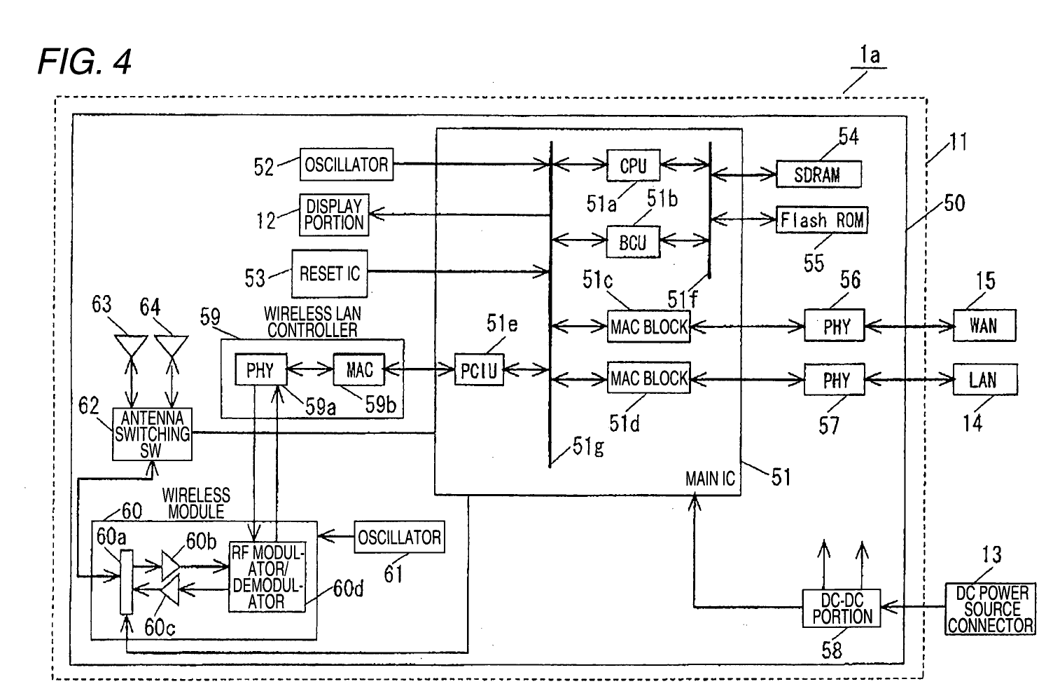

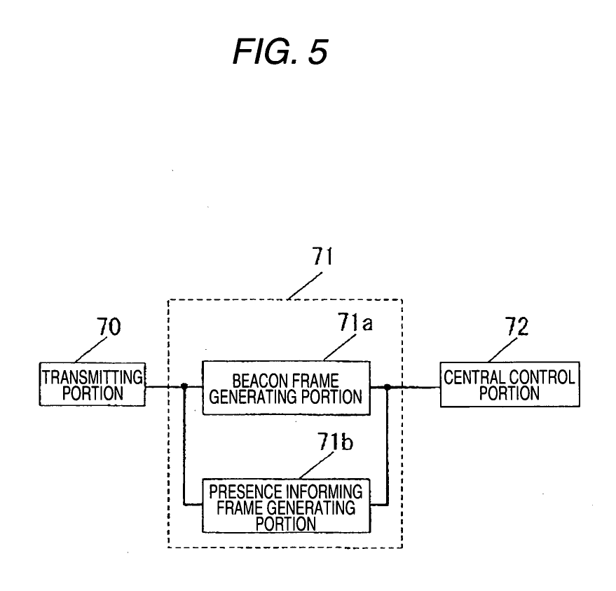

The control terminals 1a, 1b shown in FIG. 1 are routers and are provided with the same constitution and the same function. The constitution and the function of the control terminal will be explained in reference to a perspective view of an outlook of a front face of the control terminal shown in FIG. 1 of FIG. 2, a perspective view of an outlook of a back face of the control terminal shown in FIG. 1 of FIG. 3, a constitution diagram of a hardware of the control terminal shown in FIG. 1 of FIG. 4, and a functional block diagram of the control terminal shown in FIG. 1 of FIG. 5.

The control terminal 1a applied to the communication system of Embodiment 1 is a router, as shown by FIG. 2, a front face of a cabinet 11 is provided with a display portion 12 of LED (Light Emitting Diode) or the like. Further, as shown by FIG. 3, a back face of the cabinet 11 is provided with a DC (Direct Current) power source connector 13, a modular jack 14 for LAN (Local Area Network) of RJ45 or the like, and a modular jack 15 for WAN (Wide Area Network). The control terminal 1a is connected to the wired channel 4 by the modular jack 14 for LAN and the modular jack 15 for WAN. The DC power source connector 13 is connected with a power line 16 of parallel cables or the like. The modular jacks 14, 15 are connected with LAN cables, not illustrated.

Further, although the router is shown as an example of the control terminal 1a, the control terminal 1a is not particularly limited thereto but may be an apparatus having a function of an access point (for example, household electric appliance of television set or the like).

FIG. 4 is a block diagram showing an example of a constitution of a circuit module 50 constituting the hardware of the control terminal 1a provided at inside of the cabinet 11. In FIG. 4, notation 50 designates the circuit module, notation 51 designates a main IC, notation 51a designates CPU, notation 51b designates BCU (Bus Control Unit), notations 51c, 51d, 59a designate MAC blocks, notation 51e designates a PCIU (Peripheral Component Interconnect Unit) portion, notation 51f designates a main bus, notation 51g designates a local bus, notations 52, 61 designate oscillators, notation 53 designates a reset IC, notation 54 designates SDRAM (Synchronous Dynamic Random Memory), notation 55 designates Flash ROM (Flash Read Only Memory), notations 56, 57, 59b designate PHY blocks, notation 58 designates a DC-DC portion, notation 59 designates a wireless LAN controller, notation 60 designates a wireless module, notation 60a designates a transmission/reception switching switch, notation 60b designates LNA (Low Noise Amplifier), notation 60c designates PA (Power Amplifier), notation 60d designates an RF (Radio Frequency) modulator/demodulator, notation 62 designates an antenna switching switch (SW), notations 63, 64 designate antennas.

In FIG. 4, the circuit module 50 is mounted with the main IC 51, the wireless LAN controller 59, the wireless module 60 as main constituent elements according to the invention. The main IC 51 includes CPU 51a, BCU 51b for controlling flow of data on the main bus 51f and the local bus 51g, the MAC blocks 51c, 51d for controlling MAC (Medium Access Control) layers of Ethernet (registered trademark), PCIU 51e for controlling PCI bus.

CPU 51a and BCU 51b at inside of the main IC 51 are connected with Flash ROM 55 stored with programs executed by CPU 51a and fixed data and SDRAM 54 used for temporarily holding data in executing programs by CPU 51a by way of the main bus 51f CPU S1a makes access to Flash ROM 55 and SDRAM 54 by way of BCU 51b and executes programs.

Further, CPU 51a and BCU 51b are connected with the oscillator 52 for supplying clock to the main IC, the display portion 12 of LED or the like, and the reset IC 53 for outputting an initializing signal to the main IC 51, and connected with MAC blocks 51c, 51d, and PCIU 51e at inside of the main IC 51 by way of the local bus 51g. Respective constituent elements at inside of the main IC 51 are operated based on the clock supplied from the oscillator 52.

The MAC blocks 51c, 51d at inside of the main IC 51 are respectively connected to the PHY blocks 56, 57 for controlling the physical layers of Ethernet (registered trademark), and the PHY blocks 56, 57 are respectively connected with the modular jack 15 for WAN, the modular jack 14 for LAN. Further, the main IC 51 is connected to the DC-DC portion 58 for converting a DC voltage supplied from the DC power source connector 13 into a DC voltage necessary for the main IC 51, and is operated by a power source supplied from the DC-DC portion 58.

The wireless LAN controller 59 includes the MAC block 59a for controlling the MAC layer, the PHY block 59b for controlling the physical layer. PCIU 51e at inside of the main IC 51 is connected to the PHY block 59b by way of the MAC block 59a.

The wireless module 60 is set with a transmitting or receiving state from the main IC 51 and includes the transmission/reception switching switch 60a, LNA 60b for amplifying a receiving signal, PA 60c for amplifying a transmitting signal, the RF modulator/demodulator 60d for modulating to a wireless signal and demodulating from a wireless signal.

The wireless module 60 is connected to the oscillator 61 for supplying clock to the wireless module 60, the RF modulator/demodulator 60d at inside of the wireless module 60 is connected to the PHY block 59b at inside of the wireless LAN controller 59. The transmission/reception switching switch 60a at inside of the wireless module 60 is connected to the antennas 63, 64 by way of the antenna switching switch 62 for switching the antenna used from the main IC 51.

FIG. 5 is a functional block diagram of the control terminal shown in FIG. 1.

In FIG. 5, notation 72 designates a central control portion, notation 71 designates a frame generating portion, notation 71a designates a beacon frame generating portion for generating a beacon frame (first frame) including information necessary for connecting the communication terminal 2 to the control terminal per se, notation 71b designates a presence informing frame generating portion for forming a presence informing frame (second frame) including information by which the communication terminal 2 can identify the control terminal per se and having an amount of data smaller than that of the first frame, notation 70 designates a transmitting portion.

Further, in this case, in comparison with the beacon frame, the presence informing frame includes only information necessary for connecting the communication terminal 2 with the control terminal 1a, 1b and data thereof is smaller than that of the beacon frame including other various information.

In FIG. 5, the control terminal 1a includes the central control portion 72 for instructing to generate a frame, the frame generating portion 71 including the beacon frame generating portion 71a for generating the beacon frame and the presence informing frame generating portion 71b for generating the presence informing frame by instruction from the central control portion 72, and the transmitting portion for transmitting the beacon frame and the presence informing frame to the wireless channel 3a.

The function of the central control portion 72 is mainly realized by CPU 51a at inside of the main IC 51, the frame generating portion 71 is realized by the MAC block 59a at inside of the wireless LAN controller 59, the transmitting portion 70 is realized by the wireless module 60, the oscillator 61, the antenna switching SW 62, and the antennas 63, 64.

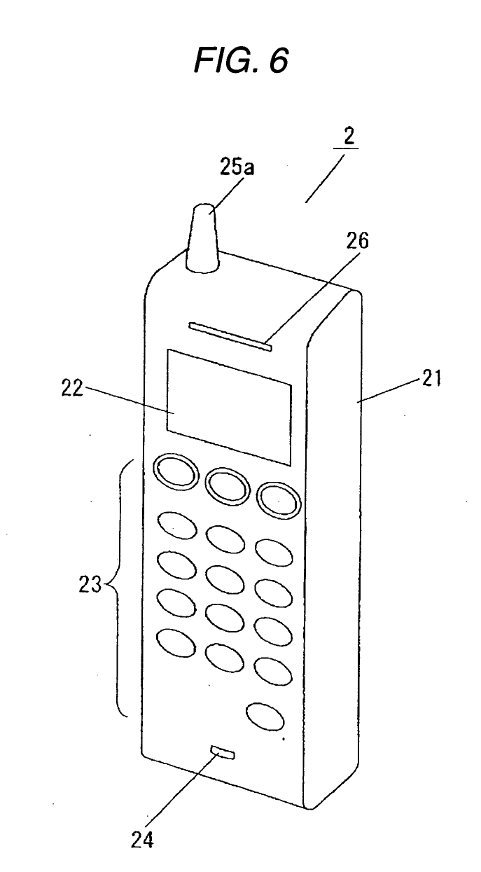

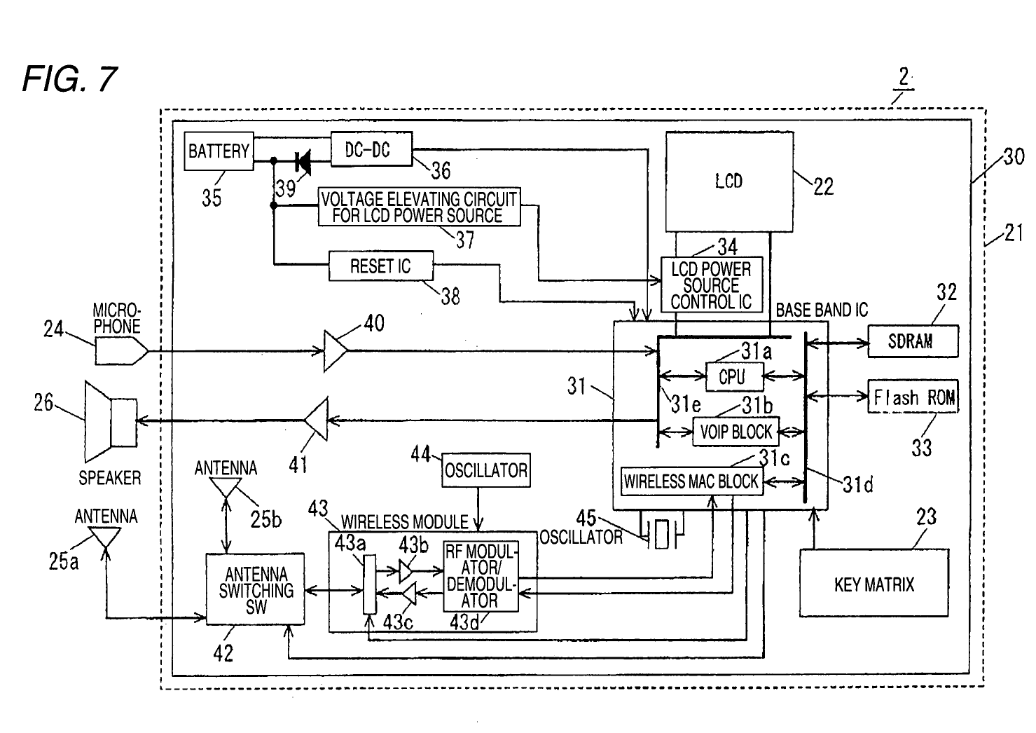

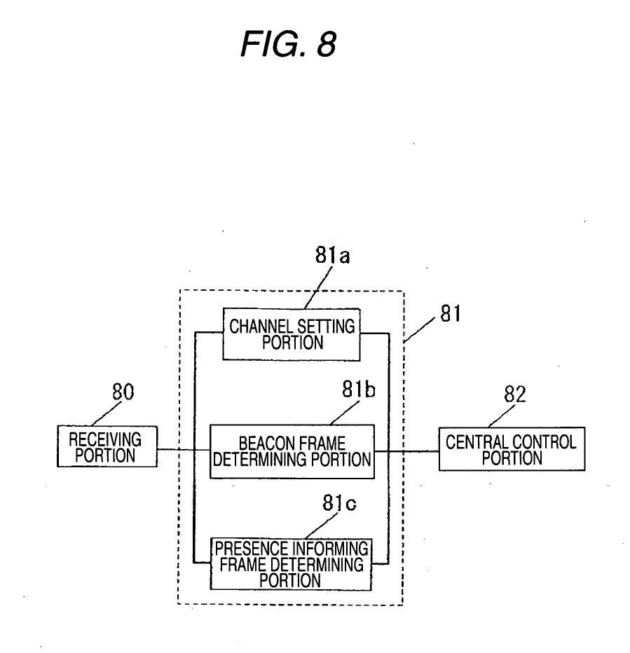

Next, the constitution and the function of the communication terminal 2 previously shown in FIG. 1 will be explained in reference to a perspective view of an outlook of the communication terminal shown in FIG. 1 of FIG. 6, a constitution diagram of a hardware of the communication terminal shown in FIG. 1 of FIG. 7, and a functional block diagram of the communication terminal shown in FIG. 1 of FIG. 8.

The communication terminal 2 is a portable telephone including a cabinet 21 as shown by FIG.6, the cabinet 21 is provided with LCD (Liquid Crystal Display) 22 for displaying a telephone number or the like, a key matrix 23 constituted by a button for designating a telephone number, a button for on hook/off hook operation and the like, a microphone 24 constituting means for inputting voice, an external antenna 25a for transmitting and receiving radio wave by way of the wireless communication paths 3a, 3b, and a speaker 26 for outputting voice from a speech counter party.

Further, although a telephone is shown as an example of the communication terminal 2, the communication terminal 2 is not particularly limited to a telephone but the communication terminal 2 may be an apparatus having a function of being connectable to the control terminals 1a, 1b constituting the access point (for example, electronic apparatus of personal computer or the like).

FIG.7 is a block diagram showing an example of a constitution of a circuit module 30 constituting a hardware of the communication terminal 2 provided at.inside of the cabinet 21. In FIG. 7, notation 30 designates the circuit module, notation 31 designates a base band IC, notation 31a designates CPU, notation 31b designates a VoIP (Voice over Internet Protocol) block, notation 31c designates a wireless MAC block, notation 31d designates a main bus, notation 31e designates a local bus, notation 32 designates SDRAM, notation 33 designates Flash ROM, notation 34 designates a power source control IC, notation 35 designates a battery, notation 36 designates a DC-DC converter, notation 37 designates a voltage elevating circuit for LCD power source, notation 38 designates a reset IC, notation 39 designates a diode, notations 40, 41 designate amplifiers, notation 42 designates an antenna switching switch (SW), notation 43 designates a wireless module, notation 43a designates a transmission/reception switching switch, notation 43b designates LNA (Low Noise Amplifier), notation 43c designates PA (Power Amplifier), notation 43d designates an RF (Radio Frequency) modulator/demodulator, notations 44, 45 designate oscillators, notation 22 designates LCD, notation 23 designates the key matrix, notation 24 designates the microphone, notation 26 designates the speaker, notation 25a designates the external antenna, and notation 25b designates an internal antenna.

In FIG. 7, the circuit module 30 is mounted with the base band IC 31, the wireless module 43, and mounted with LCD 22 and the key matrix 23 previously shown in FIG. 6 as main constituent elements according to the invention.

The base band IC 31 includes CPUM 31a, the VoIP block 31b for processing voice, the wireless MAC block 31c for controlling the MAC layer of wireless LAN, the main bus 31d, the local bus 31e. CPU 31a, the VoIP block 31b, and the wireless MAC block 31c at inside of the base band IC 31 are connected to Flash ROM 33 stored with programs executed by CPU 31a and fixed data, and SDRAM 32 used for temporarily holding date when CPU 31a executes programs and SDRAM 32 used for temporarily holding data used by VoIP block 31b and the wireless MAC block 31c by way of the main bus 31d.

Further, CPU 31a and the VoIP block 31b are connected to LCD 22, the ICD power source control IC 34 connected to the battery 35 for controlling a power source from the LCD power source voltage elevating circuit 37 for elevating a voltage of the battery 35 to a voltage necessary for driving LCD 22, the DC-DC converter 36 connected to the battery 35 by way of the diode 39 for converting the voltage of the battery 35 to a DC voltage necessary for respective constituent elements, and the reset IC 38 for outputting an initializing signal and the base band IC 31 by way of the local bus 31e.

Further, CPU 31a and the VoIP block 31b are connected to the amplifier 40 for amplifying a voice signal inputted from the microphone 24, and the amplifier 41 for amplifying a voice signal to be outputted by way of the speaker 26 by way of the local bus 31e.

Further, the base band 31 is connected to the key matrix 23, the oscillator 45 for supplying clock to the base band IC 31, the wireless module 43, and the antenna switching switch 42 for switching the antennas 25a, 25b.

The wireless module 43 includes the transmission/reception switching switch 43a, LNA 43b for amplifying a receiving signal, PA 43c for amplifying a transmitting signal, the LF modulator/demodulator 43d for modulating to a wireless signal and demodulating from a wireless signal. The wireless module 43 is connected to the oscillator 44 for supplying clock to the wireless module 43 and the antenna switching switch 42. The antenna switching switch 42 is connected to the external antenna 24a, the internal antenna 24b.

FIG. 8 is a functional block diagram showing a functional constitution according to the invention of the communication terminal 2. In FIG. 8, notation 80 designates a receiving portion, notation 81 designates a frame determining portion, notation 81a designates a channel setting portion, notation 81b designates a beacon frame determining portion, notation 81c designates a presence informing frame determining portion, notation 82 designates a central control portion.

In FIG. 8, the communication terminal 2 includes the receiving portion 80 for generating a receiving frame by subjecting a signal received from wireless channels 3a, 3b to a previously determined demodulating processing and measuring a receiving intensity of the receiving frame, the frame determining portion 81 including the channel setting portion 81a for setting a channel used by the receiving portion 80, that is, which of the wireless channels 3a, 3b is used, the beacon frame determining portion 81b for determining whether the receiving frame generated by the receiving portion 80 is a beacon frame, the presence informing frame determining portion 81c for determining whether the receiving frame generated by the receiving portion 80 is a presence informing frame, and the central control portion 82 for selecting the control terminal 1a or 1b to be connected based on a result of determination of the beacon frame determining portion 81b and the presence informing frame determining portion 81c, and the receiving frame.

The function of the receiving portion 80 is realized by the antennas 25a, 25b, the antenna switching switch 42, and the wireless module 43, the function of the beacon frame determining portion 81b and the presence informing frame determining portion 81c is realized by the wireless MAC block 31c at inside of the base band IC 31, the function of the central control portion 82 is realized mainly by CPU 31a of the base band IC 31.

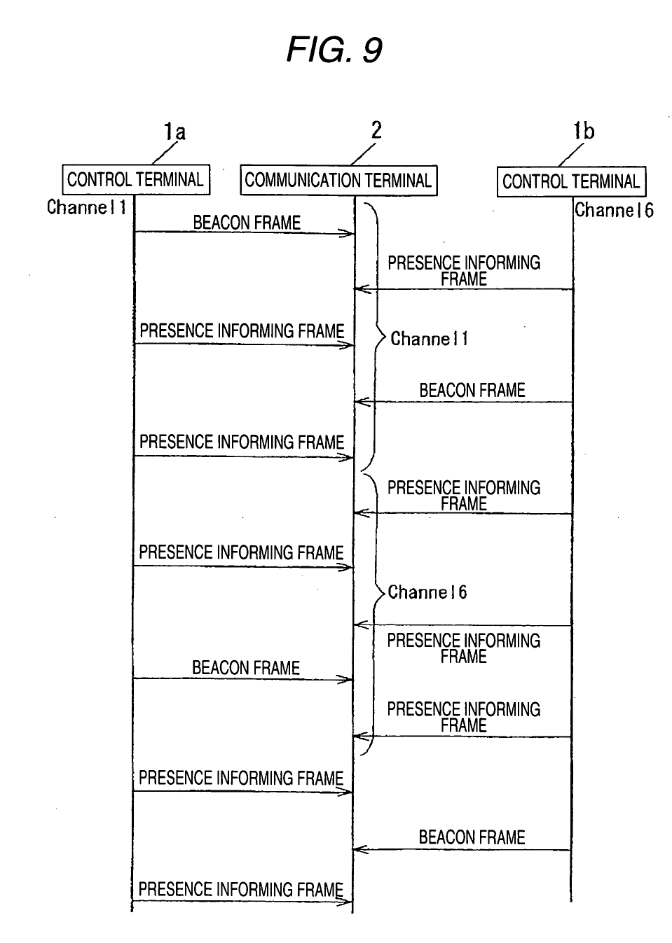

Next, an operation of the communication system according to the embodiment will be explained in reference to FIG. 1, FIG. 5, FIG. 8, and FIG. 9. First, an operation of transmitting the beacon frame and the presence informing frame by the control terminals 1a, 1b will be explained in reference to FIG. 5.

The central control portion 72 controls beacon frame transmission start time, and presence informing frame transmission start time based on a previously determined beacon period by using a time counting function of its own. The central control portion 72 outputs an instruction of generating a beacon frame to the beacon frame generating portion 71a when the beacon frame transmission start time is reached and outputs an instruction of generating a presence informing frame to the presence informing frame generating portion 71b when the presence informing frame transmission start time is reached.

The beacon frame generating portion 71a generates the beacon frame when the beacon frame generating instruction is received thereby. In the communication system according to the embodiment, a communication is carried out by using the physical layer frame 100 rectified by in IEEE 802.11 previously shown in FIG. 14. The beacon frame generating portion 71a generates the data link layer frame 103 at inside of the physical frame 100. The beacon frame generating portion 71a outputs the generated beacon frame to the transmitting portion 70.

The presence informing frame generating portion 71b generates a presence informing frame including information for transmitting presence of its own to all of communication terminals present in a range communicatable with the control terminal 1a per se, that is, all of communication terminals including communication terminals which are not under control of its own currently when instructed to generate the presence informing frame. The presence informing frame generating portion 71b generates the data link layer frame 103 in the physical layer frame 100. The presence informing frame generating portion 71b outputs the generated presence informing frame to the transmitting portion 70. The transmitting portion 70 transmits the beacon frame, or the transmitting frame constituted by subjecting the presence informing frame to a previously determined modulating processing to the wireless channel 3a.

Next, an explanation will be given of an operation of searching and selecting the control terminal 1a, 1b by receiving the beacon frame and the presence informing frame by the communication terminal 2 in reference to FIG. 8. The central control portion 82 selects one of previously determined channels to be searched as an object channel of search and informs the selected object channel to the channel setting portion 81a. Here, first, a channel in correspondence with the wireless channel 3a is selected as the object channel and is informed to the channel setting portion 81a. Further, the central control portion 82 initializes a frame counter at inside of the central control portion 82 (for example, “0”).

The channel setting portion 81a informs the object channel informed from the central control portion 82 to the receiving portion 80 to set the channel to be searched. Here, the channel in correspondence with the wireless channel 3a is selected and informed as the object channel. Therefore, the channel setting portion 81a sets the channel to the receiving portion to receive a signal by using the channel in correspondence with the wireless channel 3a.

The receiving portion 80 receives the transmitting frame transmitted by the control terminal 1a by using the channel set by the channel setting portion 81a (in this case, wireless channel 3a) and generates a receiving frame by subjecting the transmitting frame to a previously determined modulating processing. The receiving portion 80 outputs the generated receiving frame to the beacon frame determining portion 81b and the presence informing frame determining portion 81c. Further, the receiving portion 80 measures a receiving intensity in receiving the receiving frame and outputs the measured receiving intensity to the beacon frame determining portion 81b and the presence informing frame determining portion 81c along with the receiving frame as receiving intensity information.

The beacon frame determining portion 81b determines whether the receiving frame is the beacon frame. The transmitting frame transmitted by the control terminal 1a, 1b is the physical layer frame 100 rectified by IEEE 802.11 as described above, and the MAC header 104 at inside of the data link layer frame 103 includes information of what kind of a frame the date link layer frame 103 is. The beacon frame determining portion 81b determines whether the receiving frame is the beacon frame based on the information. When the receiving frame is determined to be the beacon frame, the beacon frame determining portion 81b outputs the receiving intensity information and the beacon frame received from the receiving portion 80 to the central control portion 82.

The presence informing frame determining portion 81c determines whether the receiving frame is the presence informing frame. The presence informing frame determining portion 81c determines whether the receiving frame is the beacon frame based on information of what kind of a frame the data link layer frame 103 included in the MAC header 104 at inside of the data link layer frame 103 is similar to the beacon frame determining portion 81b. When the receiving frame is determined to be the presence informing frame, the presence informing frame determining portion 81c outputs the receiving intensity information and the presence informing frame received from the receiving portion 80 to the central control portion 82.

The central control portion 82 increments the frame counter at inside of the central control portion 82 and stores the receiving intensity information when the frame (beacon frame or presence informing frame) is received. The central control portion 82 compares a count value of the frame counter with a previously determined threshold of a number of times of receiving. When the count value is smaller than the threshold of the number of times of receiving as a result of comparison, the central control portion 82 repeats an operation of incrementing the value of the frame counter and storing the receiving intensity information at each time of informing the frame and the receiving intensity information from the beacon frame determining portion 81b or the presence informing frame determining portion 81c.

When the counter value is equal to or larger than the threshold of the number of times of receiving as a result of comparison, the central control portion 82 determines whether a channel to be selected as the object channel is present. The central control portion 82 previously recognizes a channel constituting a previously determined search object. Here, the channel in correspondence with the wireless channel 3a, 3b is a channel to be searched, search of the channel in correspondence with the wireless channel 3a is finished and the channel in correspondence with the wireless channel 3b is not searched. Therefore, the central control portion 82 selects the channel in correspondence with the wireless channel 3b as the object channel and informs the channel to the channel setting portion 81a. Further, the central control portion 82 initializes the count value of the frame counter.

The channel setting portion 81a informs the object channel informed from the central control portion to the receiving portion 80 and sets the channel to be searched. Here, the channel in correspondence with the wireless channel 3b is selected and informed as the object channel. Therefore, the channel setting portion 81a sets the channel to the receiving portion 80 to receive a signal by using the channel in correspondence with the wireless channel 3b.

The receiving portion 80, the beacon frame determining portion 81b, and the presence informing frame determining portion 81c constitute the object channel by the channel in correspondence with the wireless channel 3b, receive the transmitting frame transmitted by the control terminal 1b, generate the receiving frame by subjecting the transmitting frame to the previously determined demodulating processing, measure the receiving intensity when the receiving frame is received, and inform the measured receiving intensity to the central control portion 82 along with the beacon frame or the presence informing frame as the received intensity information similar to the case of constituting the object channel by the channel in correspondence with the wireless channel 3a.

The central control portion 82 increments the frame counter at inside of the central control portion 82 and stores the receiving intensity information when the frame (beacon frame or presence informing frame) is received. The central control portion 82 compares the count value of the frame counter with the previously determined threshold of the number of times of receiving. When the count value is smaller than the threshold of the number of times of receiving as a result of comparison, the central control portion 82 repeats the operation of incrementing the value of the frame counter and storing the receiving intensity information at each time of informing the frame and the receiving intensity information from the beacon frame determining portion 81b or the presence informing frame determining portion 81c.

When the counter value becomes equal to or larger than the threshold of the number of times of receiving as a result of comparison, the central control portion 82 determines whether a channel to be selected as the object channel is present. Here, search of the channel in correspondence with the wireless channel 3a, 3b has been finished and therefore, the channel to be selected as the object the channel is not present. Therefore, the central control portion 82 determines that the channel to be selected as the object channel is not present.

The central control portion 82 selects the channel to be connected, that is, the control terminal 1a, 1b to be connected based on the receiving intensity information received by the channel to be searched or information included in the beacon frame or the presence informing frame. For example, when the control terminal 1a, 1b to be connected is selected by using only the receiving intensity information, the channel is selected based on a previously determined selecting procedure such that the channel having the largest average value of the receiving intensity information is selected, or maximum values of the receiving intensity information in the same channel are compared and the channel having the largest receiving intensity is selected or the like. Further, when the control terminal 1a, 1b to be connected is selected by using the information at inside of the beacon frame or the presence informing frame and the receiving intensity information, the control terminal improving a communicating state when the control terminal per se is connected is selected although details thereof will be described later.

The central control portion 82 shifts to an operating processing of connecting to the control terminal 1a, 1b in accordance with a previously determined procedure based on the content of the beacon frame or the presence informing frame received by the selected channel and starts the communication with a communication counter party by way of the connected control terminal 1a, 1b.

Next, in reference to a sequence diagram for explaining the operation of Embodiment 1 of the communication system according to the invention of FIG. 9, the operation of the communication system of Embodiment 1 will be explained. In FIG. 9, the control terminal 1a transmits the beacon frame at each beacon interval by using. Channel 1 and transmits three of the presence informing frames within the beacon interval. Further, the control terminal 1b transmits the beacon frame at each beacon interval by using Channel 6 and transmits three of the presence informing frames within the beacon interval.

Here, both of the beacon intervals of transmitting the beacon frames by the control terminals 1a, 1b are 80 ms, and the control terminals 1a, 1b respectively transmit the presence informing frames at elapses of 20 ms, 40 ms, 60 ms after transmitting the beacon frames. That is, the beacon intervals of the control terminals 1a, 1b and timings of transmitting the presence informing frames after transmitting the beacon frames are made to be the same. However, a timing of transmitting the beacon frame of the control terminal 1b is delayed by 30 ms after the control terminal 1a transmits the beacon frame. Therefore, at the communication terminal 2 within a range in which the control terminals 1a, 1b can communicate therewith, the beacon frames or the presence informing frames arrive alternately from the control terminal 1b and the control terminal 1b at every 10 ms such that the presence informing frame from the control terminal 1b using Channel 6 arrives 10 ms after the beacon frame from the control terminal 1a using Channel 1 arrives, the beacon frame from the control terminal 1a using Channel 1 arrives 10 ms thereafter. Further, the threshold of the number of times of receiving of the communication terminal 2 is set with “3”.

The control terminal 2, first, receives the beacon from the control terminal 1a by using Channel 1, and the central control portion 82 increments the frame counter. Thereby, the counter value of the frame counter becomes “1”. Since the threshold of the number of times of receiving is “3”, the communication terminal 2 is at standby for receiving the frame from the control terminal 1a by using Channel 1. The communication terminal 2 receives the presence informing frame from the control terminal 1a 20 ms after receiving the beacon frame. Thereby, the counter value of the frame counter becomes “2”. Since the threshold of the number of times of receiving is “3”, the communication terminal 2 is at standby for receiving the frame from the control terminal 1a by using Channel 1. The communication terminal 2 receives the presence informing frame from the control terminal 1a 20 ms after receiving the presence informing frame, that is, 40 ms after receiving the beacon frame. Thereby, the counter value of the frame counter becomes “3”, and the threshold of the number of times of receiving becomes equal to or larger than “3”. The center control portion 82 changes setting of the channel from Channel 1 to Channel 6 since the counter value of the frame counter becomes equal to or larger than the threshold of the number of times of receiving.

The communication terminal 2 receives the frame transmitted from the control terminal 1b by using Channel 6 similar to the operation using Channel 1 as described above. In FIG. 9, after changing the receiving channel from Channel 1 to Channel 6, the communication terminal 2 receives the presence informing frame, and the central control portion 82 increments the frame counter. Thereby, the counter value of the frame counter becomes “1”. Since the threshold of the number of times of receiving is “3”, the communication terminal 2 is at standby for receiving the frame from the control terminal 1b by using Channel 6. The communication terminal 2 receives the presence informing frame from the control terminal 1b 20 ms after receiving the presence informing frame. Thereby, the counter value of the frame counter becomes “2”. Since the threshold of the number of times of receiving is “3”, the communication terminal 2 is at standby for receiving the frame from the control terminal 1b by using Channel 6. The communication terminal 2 receives the presence informing frame from the control terminal 1b 20 ms after receiving the presence informing frame, that is, 40 ms after receiving a first one of the presence informing frame. Thereby, the counter value of the frame counter becomes “3”, and the threshold of the number of times of receiving becomes equal to or larger than “3”. The communication terminal 2 is previously set with Channels 1, 6 as channels to be searched. The central control portion 82 receives the beacon frames, or the presence informing frames respectively by 3 times (thresholds of numbers of times of receiving) by using the channels to be searched and therefore, the central control portion 82 finishes the searching processing. Further, the channel to be connected, that is, the control terminal 1a, 1b to be connected is selected based on the receiving intensity information received by the channels to be searched.

Further, in the above-described explanation, there is shown an example in which the communication terminal 2 switches frequencies to be searched when three of the beacon frames or the presence informed frames are received. In order to switch the frequency to be searched by receiving three of only the presence informing frames, as described above, the presence informing frame per se needs to include information necessary for connecting the communication terminal 2 to the control terminal 1a, 1b.

Hence, there may be constructed a constitution of counting the frames to be received such that at least one of the three frames to be counted necessarily includes the beacon frame.

By constituting in this way, the information necessary for connection can be obtained from the beacon frame and therefore, the presence informing frame may be made to be able to identify at least the control terminal 1a, 1b, and an amount of data of the presence informing frame can be made to be considerably smaller that in the above-described explanation.

Further, there may also be constructed a constitution in which when the communication terminal 2 receives the beacon frame, the content of the frame is stored to a memory (SDRAM 32 or the like) to learn with regard to the control terminal 1.

By constituting in this way, the presence informing frame from the control terminal 1a, 1b stored to the memory may be made to be able to only identify at least the control terminal 1, further, in the case of the control terminal 1 stored to the memory, the presence of the control terminal 1 can be confirmed by three of the presence informing frames and the operation can be switched to search the successive frequency. Further, it can be determined whether the control terminal stored to the memory is the control terminal 1a or 1b by whether the MAC address of the control terminal 1a or 1b stored to the memory coincides with the MAC address of the presence informing frame to be received.

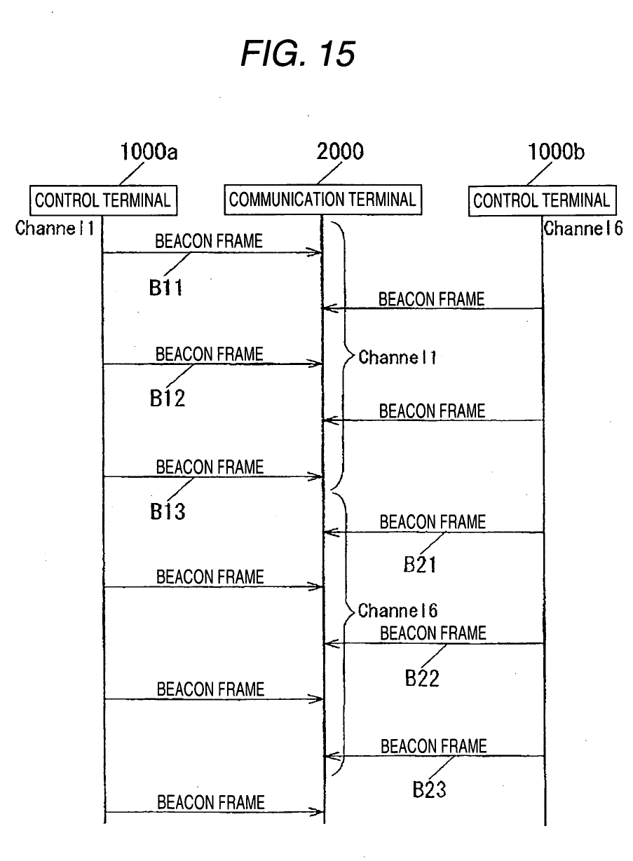

Here, the operation of searching the control terminal of the communication system of the background art explained in the background art in reference to FIG. 15 mentioned above and the operation of searching the control terminal of the communication system of Embodiment 1 according to the invention will be compared.

First, the comparison will be carried out with regard to the case of passive scan. When the beacon interval of transmitting the beacon frame by the control terminals 1000a, 1000b in the communication system of the background art is 80 ms the same as that of the beacon interval of transmitting the beacon frame by the control terminals 1a, 1b of the communication system of Embodiment 1 according to the invention, and the communication terminal 2000 receives the beacon frames from the control terminals 1000a, 1000b consecutively by 3 times respectively, the search time period of the communication system of the background art becomes a time period of an amount of 5 pieces of the beacon intervals on an average. Therefore, a search time period of the communication system of the background art becomes as shown by (Equation 1).
80×5=400 ms (Equation 1)

In contrast thereto, when according to the communication system of Embodiment 1, the presence informing frame interval of transmitting the presence informing frame by the control terminal 1a, 1b is 20 ms, and the communication terminal 2 receives the beacon frames 100 or the presence informing frames from the control terminals 1a, 1b consecutively by 3 times respectively, the search time period of the communication system of Embodiment 1 becomes a time period of an amount of 5 pieces of the presence informing frame intervals on an average. Therefore, the search time period of the communication system of Embodiment 1 becomes as shown by (Equation 2).
20×5=100 ms (Equation 2)

The search time period can be shortened from that of the communication system of the background art by 300 ms.

According to the communication system of Embodiment 1 and the communication system of the background art, the beacon frame is constituted by the physical layer frame previously shown in FIG. 14. In a case of a communication system supporting a communication terminal of an old time, in order to facilitate to synchronize the communication terminal of the old time in consideration of the communication terminal of the old time, 192 μs is needed for time periods of the physical layer preamble 101, and the PHY header 102, and a transmission data rate becomes 1 Mbps. Further, a byte number of the MAC header 104 is 24 bytes, a byte number of FCS 106 is 4 bytes. Here, when a byte number of the frame body 105 is tentatively set to 100 bytes, a time period necessary for transmitting the beacon frame in the communication system supporting the communication terminal of the old time becomes as shown by (Equation 3).
192+(24+100+4)×8/1=1216 μs (Equation 3)

In a case of a communication system for supporting only a communication terminal of a new type without supporting the communication terminal of the old time, 96 μs is needed for time periods of the physical layer preamble 101, and the PHY header 102, and the transmission data rate becomes 11 Mbps. Further, the byte number of the MAC header 104 is 26 bytes in conformity with a standard candidate of 102.11e in order to ensure QoS (Quality of Service) of transmission, and the byte number of FCS 106 is 4 bytes. Here, when the byte number of the frame body 105 is tentatively set to 100 bytes, a time period necessary for transmitting the presence informing frame in the communication system supporting the communication terminal of the new type becomes as shown by (Equation 4).
96+(26+100+4)×8/11≈190.55 μs (Equation 4)

With regard to the presence informing frame, 3 pieces of the presence informing frames are transmitted at the beacon interval in FIG. 9. Therefore, 3 times of a time period of 190.55 μs necessary for transmitting the presence informing frames is used at the beacon frame interval and therefore, an efficiency of medium is substantially deteriorated by (Equation 5) shown below.
190.55×3 μs/80 ms×100≈0.715% (Equation 5)

In order to carry out search assumedly by 100 ms the same as the time period of the communication system of Embodiment 1 in the communication system of the background art, the beacon interval needs to reduce to ¼ and in this case, the efficiency of the communication time period is substantially deteriorated by (Equation 6) shown below.
1216×3 μs/80 ms×100=4.560% (Equation 6)

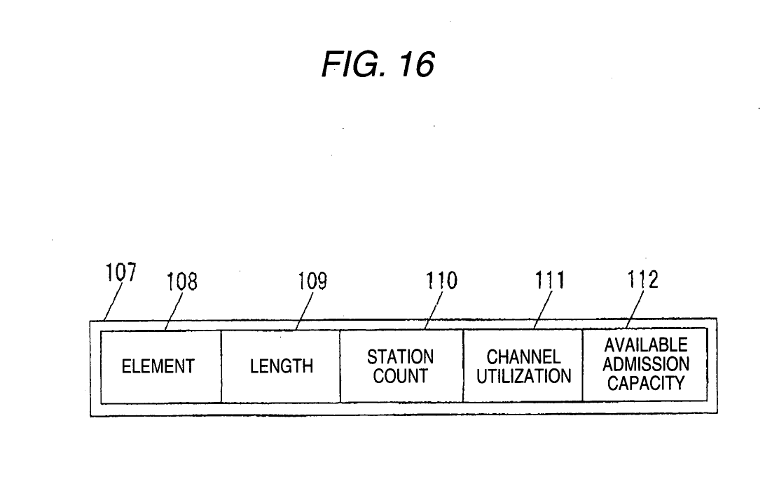

Further, when information which the presence informing frame generating portion 71b of the control terminal 1a, 1b stores to the frame body 105 of the presence informing frame is constituted only by 7 bytes shown in FIG. 16 to be transmitted from the transmitting portion 70, a time period necessary for transmitting the presence informing frame becomes as shown by (Equation 7).
96+(26+7+4)×8/11≈122.91 μs (Equation 7)

Since 3 times of the time period is used in the beacon interval, the efficiency of the medium is deteriorated substantially by (Equation 8).
122.91×3 μs/80 ms×100≈0.461% (Equation 8)
In this case, the central control portion 82 of the communication terminal 2 determines a destination of connection by determining from a situation of controlling the communication terminal 2 of the control terminal 1a, 1b informed from the beacon frame determining portion 81b, and the presence informing frame determining portion 81c and information of congestion and the receiving intensity information of the presence informing frame.

Further, in a case of storing information of only 1 byte indicating whether the communication terminal is newly added to control from a terminal number of the communication terminal currently controlled by the control terminals 1a, 1b as information stored to the frame body 105 of the presence informing frame, a time period necessary for transmitting the presence informing frame becomes as shown by (Equation 9).
96+(26+1+4)×8/11≈118.55 μs (Equation 9)

Since 3 times of the time period is used at the beacon interval, the efficiency of the medium is deteriorated substantially by (Equation 10) shown below.
118.55×3 μs/80 ms×100≈0.445% (Equation 10)

In this case, the central control portion 82 of the communication terminal 2 can recognize whether a communication terminal can newly be added previously to the information of the frame body 105 of the presence informing frame to control and it is not necessary to determine the congestion. Therefore, a destination of connection may be determined only by the receiving intensity information of the presence informing frame from the control terminal which can be controlled by adding the communication terminal.

Finally, when the frame body 105 of the presence informing frame is deleted, that is, when the byte number of the frame body 105 is set to 0 byte, a time period necessary for transmitting the presence informing frame becomes as shown by (Equation 11).
96+(26+0+4)×8/11≈117.82 μs (Equation 11)

Since 3 times of the time period is used in the beacon interval, the efficiency of the medium is deteriorated substantially by (Equation 12).
117.82×3 μs/80 ms×100≈0.442% (Equation 12)

In this case, the central control portion 72 of the control terminal 1a, 1b instructs the presence informing frame generating portion 71b to generate the presence informing frame of constituting the byte number of the frame body 105 by 0 byte only when the control terminal can be controlled by newly adding the communication terminal, that is, the presence informing frame by the physical layer frame 100 in which the frame body 105 is not present such that the presence informing frame generating portion 71b generates the presence informing frame by the physical layer frame 100 in which the frame body 105 is not present to be transmitted to the transmitting portion 70. Further, the central control portion 82 of the communication terminal 2 can recognize that the control terminal 1a, 1b can be controlled by adding the communication terminal 2 by informing the presence informing frame which is received by the receiving portion 80 and in which the frame body 105 is not present from the presence informing frame determining portion 81c, and a destination of connection may be determined only by the receiving intensity information of the presence informing frame informed.

As has been explained above, according to Embodiment 1, the control terminal 1a, 1b transmits the beacon frame including information necessary for connecting the communication terminal 2 to the control terminal 1a, 1b per se by the previously determined beacon interval, and three of the presence informing frames including information of capable of identifying the control terminal 1a, 1b per se and having a data amount smaller than that of the beacon frame are transmitted within the beacon interval.

The communication terminal is made to confirm presence of the control terminal 1a, 1b to be connected based on the beacon frame and/or the presence informing frame received and therefore, in comparison with passive scan of selecting the control terminal 1a, 1b to be connected only by the beacon frame shown in the background art, the time period of searching the control terminal 1a, 1b can be shortened.

Further, by using the presence informing frame having the data amount smaller than that of the beacon frame, a band of frequencies used can be restrained from being compressed.

(Embodiment 2)

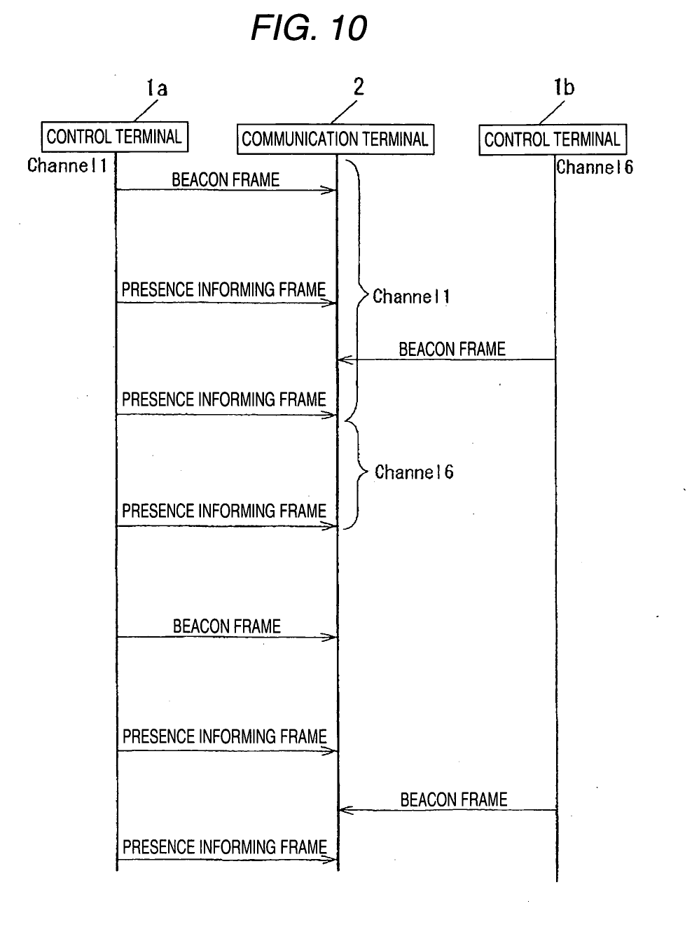

Embodiment 2 of the invention will be explained in reference to FIG. 10. A constitution of a communication system of Embodiment 2 is the same as the communication system of Embodiment 1 previously shown in FIG. 1 and therefore, an explanation thereof will be omitted here.

According to Embodiment 1 mentioned above, the control terminals 1a, 1b in the communication system respectively transmit the beacon frame and the presence informing frame. According to Embodiment 2, the control terminal 1a, 1b transmits the presence informing frame only when the control terminal 1a, 1b can be controlled by newly adding the communication terminal 2 and transmits only the beacon frame when the control terminal 1a, 1b cannot be controlled by newly adding the communication terminal 2.

Although the constitution and the function of the control terminal 1a, 1b of Embodiment 2 are substantially the same as those of Embodiment 1, Embodiment 2 differs from Embodiment 1 in a condition of outputting the instruction of generating the presence informing frame by the central control portion 72. Although in Embodiment 1, the central control portion 72 outputs instruction of generating the presence informing frame when time of starting to transmit the presence informing frame is reached, according to Embodiment 2, when the time of starting to transmit the presence informing frame is reached, it is determined whether the control terminal 1a, 1b per se can be controlled by adding the communication terminal 2. Specifically, it is determined whether the control terminal 1a, 1b can be controlled by newly adding the communication terminal 2 based on a state of using the channel, a rate of using the medium of the control terminal 1a, 1b per se or the like. Further, only when it is determined that the control terminal 1a, 1b can be controlled by newly adding the communication terminal 2, the instruction of generating the presence informing frame is outputted to the presence informing frame generating portion 71b.

The operation of the communication system of Embodiment 2 will be explained in reference to a sequence diagram for explaining the operation of Embodiment 2 of the communication system according to the invention of FIG. 10. In FIG. 10, the control terminal 1a transmits the beacon frame and transmits three of the presence informing frames within the beacon interval at each beacon interval by using Channel 1. Further, although the control terminal 1b transmits the beacon frame at each beacon interval by using Channel 6, the control terminal 1b determines that the control terminal 1b cannot be controlled by newly adding the communication terminal 2 and does not transmit the presence informing frame within the beacon interval.

Here, both of the beacon intervals of transmitting the beacon frames by the control terminals 1a, 1b are 80 ms, the control terminal 1a transmits the presence informing frames after elapses of 20 ms, 40 ms, 60 ms respectively after transmitting the beacon frame. Further, a timing of transmitting the beacon frame of the control terminal 1b is delayed by 30 ms after the control terminal 1a transmits the beacon frame. Further, the threshold of the number of times of receiving of the communication terminal 2 is set to “3”.

In FIG. 10, the communication terminal 2 is connected to the control terminal 1a and needs to receive the beacon frame transmitted from the control terminal 1a. Therefore, the central control portion 82 of the communication terminal 2 designates Channel 1 to the channel setting portion 81a and carries out reception at time at which the control terminal 1a is scheduled to transmit the beacon frame.

When the communication terminal 2 needs to receive the beacon frames or the presence informing frames by 3 times in order to determine whether connection to the control terminal 1a which is being connected currently is continued, the central control portion 82 of the communication terminal 2 switches the channel (receiving frequency) from Channel 1 to Channel 2 by instructing the channel setting portion 81 a to change the channel from Channel 1 to Channel 6 after receiving one piece of the beacon frame and two pieces of the presence informing frames from the control terminal 1a.

After switching the channel from Channel 1 to Channel 6, the central control portion the central control portion 82 of the communication terminal 2 is at standby for being informed that the beacon frame or the presence informing frame is received. However, the control terminal 1b does not transmit the presence informing frame. Therefore, the central control portion 82 is not informed of the receiving intensity information and the presence informing frame from the presence informing frame determining portion 81c even after an elapse of the interval of the presence informing frame (20 ms in this case) after switching the channel. When the control terminal 1b is not informed of the receiving intensity information and the presence informing frame from the presence informing frame determining portion 81c even after the elapse of the interval of the presence informing frame (20 ms in this case) after switching the channel, the central control portion 82 determines that the connectable control terminal is not present in Channel 6 and determines to continue to connect to the control terminal 1a which is being connected currently.

When the communication terminal 2 is informed of the receiving intensity information and the presence informing frame from the presence informing frame determining portion 81c within the interval of the presence informing frame (20 ms in this case) after switching the channel, the central control portion 82 selects the control terminal to be connected based on the receiving intensity information and the information included in the beacon frame or the presence informing frame or the like after receiving the beacon frames or the presence informing frames consecutively by an amount of the threshold of the number of times of receiving by using Channel 6 similar to Embodiment 1 mentioned above.

As has been explained above, according to Embodiment 2, the control terminal 1a, 1b transmits the presence informing frame only when it is determined that the control terminal 1a, 1b per se can be controlled by newly adding the communication terminal 2 and therefore, the communication terminal 2 can recognize that the communicatable control terminal 1a, 1b is present only when the presence informing frame is received thereby, and the medium necessary in selecting the control terminal 1a, 1b to be connected can be restrained.

(Embodiment 3)

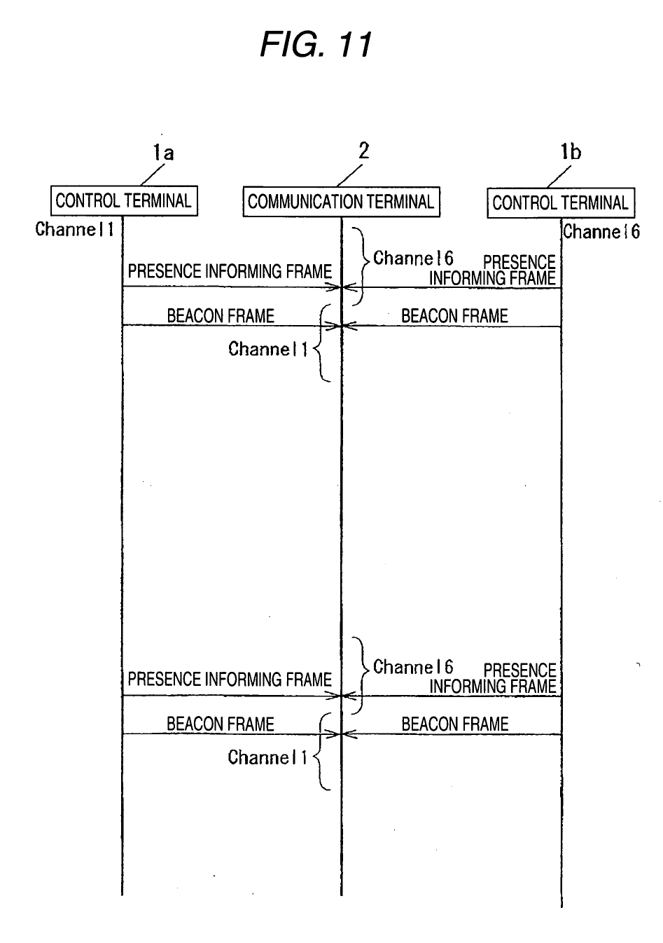

Embodiment 3 according to the invention will be explained in reference to FIG. 11. A constitution of a communication system of Embodiment 3 is the same as the communication system of Embodiment 1 previously shown in FIG. 1 and therefore, an explanation thereof will be omitted here.

According to Embodiment 1 mentioned above, the control terminals 1a, 1b in the communication system respectively transmit the beacon frame and the presence informing frames respectively nonsynchronizingly. According to Embodiment 3, the control terminals 1a, 1b transmit the beacon frame and the presence informing frames by synchronizingly with each other by communicating with each other respectively by using the wired Channel 4.

Although the constitution and the function of the control terminals 1a, 1b of Embodiment 3 are substantially the same as those of Embodiment 1 mentioned above, the constitutions and the functions differs from each other in that the central control portions 72 transmit the beacon frames by being synchronized with each other by way of the wired Channel 4. Although not illustrated in FIG. 5 mentioned above, the control terminals 1a, 1b transmit the beacon frames and the presence informing frames by being synchronized with each other by being communicated with each other by using a wired interface constituted by the MAC blocks 51c, 51d and the PHY blocks 56, 57 in the constitution diagram of the hardware previously shown in FIG. 4.

Next, an operation of the communication system of Embodiment 3 will be explained in reference to a sequence diagram for explaining the operation of Embodiment 3 of the communication system according to the invention of FIG. 11. In FIG. 11, the control terminals 1a, 1b are synchronized with each other by being communicated with each other by way of the wired Channel 4, the control terminal 1a transmits the beacon frame and the presence informing frame by using Channel 1, and the control terminal 1b transmits the beacon frame and the presence informing frame by using Channel 6. Further, CPU 51a, the central control portion 82 of the control terminal 1a, 1b output the instruction of generating the presence informing frame to the presence informing frame generating portion 71b immediately before outputting the instruction of generating the beacon frame to the beacon frame generating portion 71a.

In FIG. 11, the communication terminal 2 is connected to the control terminal 1a and needs to receive the beacon frame transmitted from the control terminal 1a. Therefore, the central control portion 82 of the communication terminal 2 designates Channel 1 to the channel setting portion 81a at time at which the control terminal 1a is scheduled to transmit the beacon frame and carries out reception by using Channel 1. Further, the central control portion 82 of the communication terminal 2 designates Channel 6 to the channel setting portion 81a for searching the control terminal 1b present at Channel 6 before time at which the beacon frame is scheduled to transmit from the control terminal 1a, 1b and is at standby for receiving the presence informing frame from the control terminal 1b.

The central control portion 82 of the communication terminal 2 determines whether connection to the control terminal 1a is continued, or connection is changed to the control terminal 1b by the receiving intensity information of the beacon frame informed from the beacon frame determining portion 81b and transmitted by the control terminal 1a, as well as the receiving intensity information of the presence informing frame informed from the presence informing frame determining portion 81c and transmitted by the control terminal 1b.

Here, the beacon frame interval is set to 80 ms, a time period necessary for transmitting the presence informing frame is 190.5 μs, a time period necessary for transmitting the beacon frame is 1216 μs. When a time period necessary for switching channels is set to 200 μs, transmission of the presence informing frame is started 400 μs before the beacon frame.

When 3 pieces of the beacon frames or the presence informing frames need to be received in order to search the control terminal, according to passive scan of the communication system of the background art, a time period necessary for searching Channel 1 and Channel 6 is a time period of an amount of 5 pieces of the beacon intervals on an average and is as shown by (Equation 13).
80×5=400 ms (Equation 13)

In contrast thereto, a time period of searching the control terminal in the communication system of Embodiment 3 is constituted by a time period of an amount of 2.5 pieces of the beacon intervals on an average, a time period of transmitting the presence informing frame per se, and the time period necessary for switching channels and is as shown by (Equation 14).
80×2.5+0.2+0.2=200.4 ms (Equation 14)

Further, a time period by which the communication terminal 2 operated by a power saving mode needs to make power ON is constituted by a time period of the presence informing frame, the time period of switching channels, and the time period of receiving the beacon frame within the beacon interval and is as shown by (Equation 15).
200+200+1216=1616 μs (Equation 15)

Low power saving formation can be achieved in comparison with the communication terminal of the communication system of the background art.

As has been explained above, according to Embodiment 3, the control terminals 1a, 1b present in the system are synchronized with each other by being communicated with each other by way of the wired Channel 4 and transmit the beacon frame and therefore, when communication ranges of a plurality of the control terminals 1a, 1b operated at the same frequency (channel) do not overlap each other, the communication terminal 2 can carry out reception by recognizing time of transmitting the beacon frames, presence of the communicatable control terminals 1a, 1b can be recognized by searching one frequency in a short period of time and power consumption of the control terminals 1a, 1b in searching can be restrained.

Further, although according to Embodiment 3, the control terminals 1a, 1b synchronize the beacon frames or the presence informing frames by being communicated with each other by using the wired Channel 4, communication between the control terminals 1a, 1b is not limited to the wired Channel 4 but other transmission channel of a wireless channel or the like may be used therefor.

(Embodiment 4)

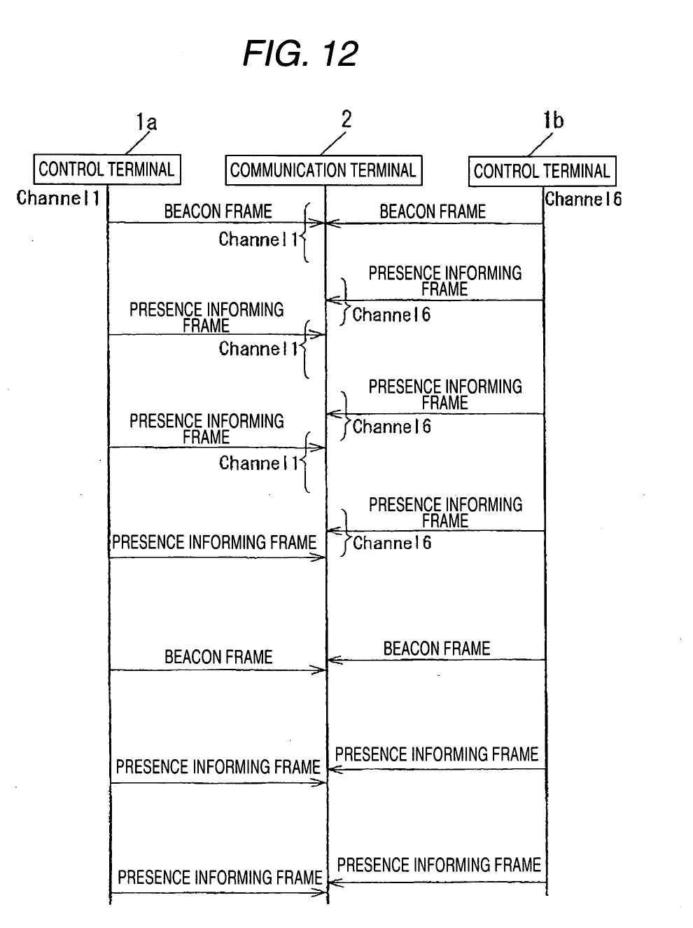

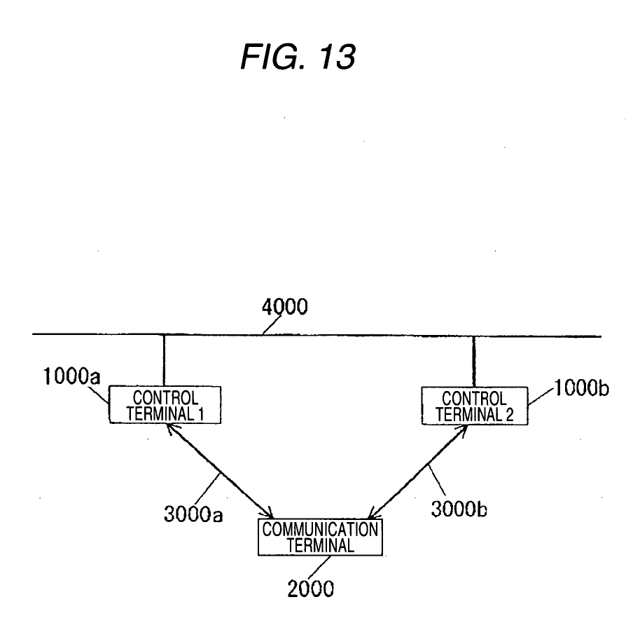

Embodiment 4 of the invention will be explained in reference to FIG. 12. A constitution of a communication system of Embodiment 4 is the same as the communication system of Embodiment 1 previously shown in FIG. 1 and therefore, an explanation thereof will be omitted here.

According to Embodiment 3 mentioned above, the control terminals 1a, 1b in the communication system transmit the beacon frames and the presence informing frames by being synchronized with each other by being communicated with each other respectively by using the wired Channel 4. According to Embodiment 4, the control terminals 1a, 1b transmit the beacon frames by being synchronized with each other by being communicated with each other respectively by using the wired Channel 4 and with regard to the presence informing frame, the control terminals 1a, 1b transmit the presence informing frames by being shifted from each other over time such that the presence informing frames do not overlap each other. That is, according to Embodiment 4, the control terminals 1a, 1b transmit the beacon frames at the same time and transmit the presence informing frames respectively after elapses of time periods different from each other after transmitting the beacon frames.

Although the constitution and the function of the control terminals 1a, 1b of Embodiment 4 are substantially the same as those of Embodiment 3 mentioned above, the presence informing frame transmission start time at which the central control portion 72 outputs instruction of generating the presence informing frame to the presence informing frame generating portion 71b is set to differ by the control terminal 1a and the control terminal 1b.

Next, an operation of the communication system of Embodiment 4 according to the invention will be explained in reference to a sequence diagram for explaining the operation of Embodiment 4 of the communication system according to the invention of FIG. 12. In FIG. 11, the control terminals 1a, 1b are synchronized with each other by being communicated with each other by way of the wired Channel 4, the control terminal 1a transmits the beacon frame by using Channel 1, the control terminal 1b transmits the beacon frame by using Channel 6. That is, the control terminals 1a, 1b transmit the beacon frames at the same time.

Further, the control terminal 1a transmits the presence informing frame by using Channel 1 and the control terminal 1b transmits the presence informing frame by using Channel 6 such that the presence informing frames do not overlap each other. That is, the control terminal 1a and the control terminal 1b transmit three of the presence informing frames within the beacon interval at times different from each other. Specifically, the beacon intervals of the control terminals 1a, 1b are 80 ms, the control terminal 1atransmits the presence informing frames after elapses of 20 ms, 40 ms, 60 ms after transmitting the beacon frame, and the control terminal 1b transmits the presence informing frames 400 μs before the control terminal 1a transmits presence informing frame in consideration of a time period necessary for switching channels (here, 200 μs), that is, after elapses of 19.6 ms, 39.6 ms, 59.6 ms after transmitting the beacon frame. Further, a time period necessary for transmitting the presence informing frame is set to 190.5 μs.

In FIG. 12, the communication terminal 2 is connected to the control terminal 1a, and needs to receive the beacon frame transmitted from the control terminal 1a. Therefore, the central control portion 82 of the communication terminal 2 designates Channel 1 to the channel setting portion 81a at time at which the control terminal 1a is scheduled to transmit the beacon frame and carries out reception by using Channel 1. Further, the central control portion 82 of the communication terminal 2 designates Channel 6 to the channel setting portion 81a in order to search the control terminal 1b present in Channel 6 before time at which the beacon frames from the control terminals 1a, 1b are scheduled to transmit and is at standby for receiving the presence informing frame from the control terminal 1b. That is, the communication terminal 2 switches Channel 1 and Channel 6 alternately in order to search the control terminals 1a, 1b.

When 3 pieces of the beacon frames or the presence informing frames need to be received in order to search the control terminals 1a, 1b, when the control terminals 1a, 1b are started to search from initial ones of the beacon frames, search is finished by a third one of the presence informing frame transmitted by the control terminal 1b. Therefore, a time period necessary for searching the control terminals 1a, 1b becomes about 60 ms and search is carried out by a time period shorter than a time period necessary for search in the communication system of the background art previously explained in Embodiment 1.

Further, in FIG. 12, the shortest search time period is constituted when search is started from an initial one of the presence informing frame transmitted by the control terminal 1b and search is finished by a third one of the presence informing frame transmitted by the control terminal 1a. Therefore, a time period necessary for searching the control terminal 1a, 1b becomes 40.8 ms. The time period of 40.8 ms is an amount of two of the intervals of the presence informing frames and becomes a time period constituted by adding an amount of 2 times of time periods of switching channels and a time period necessary for transmitting 2 pieces of the presence informing frames. Also in this case, search is carried out by a time period shorter than the time period necessary for searching in the communication system of the background art previously explained in. Embodiment 1.

As has been explained above, according to Embodiment 4, the control terminals 1a, 1b transmit the beacon frames or the presence informing frames by being synchronized with each other by being communicated with each other by way of the wired channel 4 and therefore, when communication ranges of a plurality of the control terminals 1a, 1b operated by the same frequency (channel) overlap each other, the communication terminal 2 can carry out reception by recognizing time of transmitting the beacon frame or the presence informing frame, presence of the communicatable control terminal 1a, 1b can be recognized by searching one frequency by a short period of time and power consumption in searching the control terminals 1a, 1b can be restrained.

Further, although according to Embodiment 4, the control terminals 1a, 1b communicate with each other by using the wired channel 4 to synchronize the beacon frames or the presence informing frames, the communication between the control terminals 1a, 1b is not limited to the wired channel 4 but other channel of the wireless channel or the like may be used.

Further, although in Embodiments 1 through 4, an explanation has been given by taking an example of a case of one set of the communication terminal and two sets of the control terminals, a number of sets of communication terminals and a number of sets of control terminals are not limited thereto.

Further, although according to Embodiments 1 through 4, functions of the beacon frame generating portion 71a and the presence informing frame generating portion 71bof the control terminal 1a, 1b are realized by the MAC block 59a at inside of the wireless LAN controller 59, the functions may be realized by CPU 51a at inside of the main IC 51. Further, although functions of the channel setting portion 81a, the beacon frame determining portion 81b and the presence informing frame determining portion 81c of the communication terminal 2 are realized by the wireless MAC block 31c of the base band IC 31, the functions may be realized by CPU 31a at inside of the base band IC 31.

Further, although according to Embodiments 1 through 4, in order to confirm the connectable control terminals, an explanation has been given of a case of receiving threes of the beacon frames and the presence detecting frames at a certain frequency and switching the frequency to other frequency, the invention is not limited to receiving threes thereof.

Further, although an explanation has been given of a case in which channels to be searched are constituted by Channel 1 and Channel 6, the invention is not limited to searching the two channels but more channels may be searched.

As described above, the communication system according to the invention is useful when the time period of searching the control terminal to which the communication terminal is to be connected is requested to shorten, particularly, suitable for the communication system constituting the communication terminal by a wireless telephone communication terminal or PDA which needs to restrain power consumption more than an electronic apparatus for wireless LAN always conducted with electricity.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based upon and claims the benefit of priority of Japanese Patent Application No. 2005-324496 filed on Nov. 9, 2006, the contents of which are incorporated herein by reference in its entirety.

What is claimed is:

1. A communication system comprising:
a control terminal and a communication terminal connected to the control terminal by way of a wireless channel;
the control terminal comprising:
a control terminal side control unit for instructing to generate a first frame including information necessary for connecting the communication terminal to the control terminal per se at every predetermined time interval and instructing to generate at least one or more of second frames each including information by which the communication terminal can identify the control terminal per se and having a data amount smaller than a data amount of the first frame within the first frame interval;
a wireless controller for generating the first frame and the second frame in accordance with an instruction of generating the frames from the control terminal side control unit; and
a transmitting unit for transmitting the first frame and the second frame generated by the wireless controller to the wireless channel by using a frequency previously allocated to the control terminal per se; and
the communication terminal comprises:
a receiving unit for receiving the frame from the wireless channel at the instructed frequency;
a wireless module for determining whether the frame received by the receiving unit is the first frame or the second frame; and
a communication terminal side control unit for instructing the frequency to be searched and confirming presence of the control terminal based on the first frame or the second frame determined by the wireless module.

2. The communication system according to claim 1, wherein the second frame is transmitted at a transmission rate higher than a transmission rate of the first frame.

3. The communication system according to claim 1, wherein the control terminal generates the second frame including a portion of the information for connecting the communication terminal to the control terminal per se.

4. The communication system according to claim 1, wherein the control terminal generates the second frame including a number of sets of the communication terminals at least controlled by the control terminal per se, or a state of using a medium.

5. The communication system according to claim 1, wherein when the control terminal per se cannot add a new one of the communication terminal to control, the control terminal generates the second frame including that the control terminal per se cannot add the new one of the communication terminal to control.

6. The communication system according to claim 1, wherein when the control terminal per cannot add a new one of the communication terminal to control, the control terminal does not generate the second frame.

7. The communication system according to claim 1, wherein there are present a plurality of the control terminals; and
wherein when the communication terminal receives predetermined numbers of the first frames and the second frames in searching a certain frequency, the frequency is switched to search other frequency.

8. The communication system according to claim 7, wherein when the frequency to be searched is switched at each time of receiving a predetermined number of the frames, the communication terminal counts the predetermined number such that at least one of the first frame is present in the predetermined number of the frames.

9. The communication system according to claim 7, wherein the communication terminal includes a memory for storing a frame content of the first frame when the first frame is received; and
wherein the communication terminal utilizes information of the memory in a case in which the first frame or the second frame is a frame from the same control terminal stored to the memory when the first frame or the second frame is received.

10. The communication system according to claim 7, wherein the control terminals are communicated with each other and the control terminals generate and transmit the first frames at the same time.

11. The communication system according to claim 10, wherein the control terminals generate the second frames at the same time.

12. The communication system according to claim 7, wherein the communication terminal measures a receiving intensity when the first frame or the second frame is received; and
wherein the communication terminal selects the control terminal to be selected based on information of the receiving intensity from the control terminals presence of which is confirmed based on the received first frame and received the second frame.

13. A control terminal which informs presence of the control terminal per se by way of a wireless channel by using a previously determined frequency, and is select by a communication terminal and connected to the communication terminal, the control terminal comprising:
a control terminal side control unit for outputting to instruct to generate a first frame including information necessary for connecting the communication terminal to the control terminal per se at every predetermined time interval, and outputting to instruct to generate at least one or more of second frames each including information by which the communication terminal can identify the control terminal per se and having a data amount smaller than a data amount of the first frame within the interval of the first frame;
a wireless controller for generating the first frame or the second frame in accordance with an instruction of generating the frame from the control terminal side control unit; and
a transmitting unit for transmitting the first frame or the second frame generated by the wireless controller to the wireless channel by using a frequency previously allocated to the control terminal per se.

14. The control terminal according to claim 13, wherein the second frame is transmitted by a transmission rate higher than a transmission rate of the first frame.

15. The control terminal according to claim 13, wherein the control terminal generates the second frame including a portion of the information for connecting the communication terminal to the control terminal per se.

16. The control terminal according to claim 13, wherein the control terminal generates the second frame including a number of sets of the communication terminals controlled at least by the control terminal per se, or a state of using a medium.

17. The control terminal according to claim 13, wherein when the control terminal per se cannot add a new one of the communication terminal to control, the control terminal generates the second frame including that the control terminal per se cannot add the new one of the communication terminal to control.

18. The control terminal according to claim 13, wherein when the control terminal per se cannot add a new one of the communication terminal to control, the second frame is not generated.

19. A communication terminal for carrying out a wireless communication with a control terminal for outputting a first frame including information necessary for connecting the communication terminal to the control terminal per se at every predetermined time interval and outputting at least one or more of second frames each including information by which the communication terminal can identify the control terminal per se and having a data amount smaller than a data amount of the first frame within the first frame interval by using a previously determined frequency, the communication terminal comprising:
a receiving unit for receiving the frame from a wireless channel at the instructed frequency;
a wireless module for determining whether the frame received by the receiving unit is the first frame or the second frame; and
a communication terminal side control unit for instructing the frequency to be searched and confirming presence of the control terminal based on the first frame or the second frame determined by the wireless module.

20. The communication terminal according to claim 19, wherein there are a plurality of the control terminals; and
wherein when predetermined numbers of the first frames and the second frames are received in searching a certain frequency, the frequency is switched to search other frequency.

21. The communication terminal according to claim 20, wherein when the frequency to be searched is switched at every time of receiving the predetermined number of the frames, the communication terminal counts the predetermined number such that at least one of the first frame is present in the predetermined numbers of the frames.

22. The communication terminal according to claim 20, wherein the communication terminal includes a memory for storing a frame content of the first frame when the first frame is received; and
wherein information of the memory is utilized in a case in which the first frame or the second frame is a frame from the same control terminal stored to the memory when the first frame or the second frame is received.

23. The communication terminal according to claim 20, wherein a receiving intensity is measured when the first frame or the second frame is received; and
wherein the control terminal to be connected is selected based on information of the receiving intensity from the control terminal presence of which is confirmed based on the received first frame or the received second frame.
